(19) United States
(12) Patent Application Publication
(10) Pub. No.: US 2009/0326730 A1
(43) Pub. Date: Dec. 31, 2009

(54) APPARATUS AND METHOD FOR CONTROLLING ACTIVATION OF AN ELECTRONIC DEVICE

(75) Inventors: Bojana Bjeljac, Burnaby (CA); Ian Ashdown, West Vancouver (CA); Ion Toma, Richmond (CA)

Correspondence Address: Philips Intellectual Property and Standards, P.O. Box 3001, Briarcliff Manor, NY, 10510-8001, US

(73) Assignee: TIR TECHNOLOGY LP, Burnaby, British Columbia (CA)

(21) Appl. No.: 12/282,645

(22) PCT Filed: Mar. 14, 2007
(86) PCT No.: PCT/CA07/00408

§ 371 Date: Feb. 9, 2009

Related U.S. Application Data
(60) Provisional application No. 60/791,721, filed on Apr. 13, 2006.

(30) Foreign Application Priority Data
Mar. 14, 2006 (CA) 2539462

(51) Int. Cl. G06F 1/26

(52) U.S. Cl. 700/296

(57) ABSTRACT

The present invention provides a method and apparatus for controlling the activation of an electronic device. For a desired activation ratio, which defines the “ON” time relative to the “OFF” time of the electronic device for a given time period, the method and apparatus according to the present invention evaluates an activation sequence. The activation sequence comprises two or more activation time periods and one or more deactivation periods, wherein the ratio between the two or more activation periods and the predetermined time period is equivalent to the desired activation ratio.

### FIELD OF THE INVENTION

The present invention pertains to the field of electronic devices and in particular to a method and apparatus for controlling the activation of an electronic device.

### BACKGROUND

Pulse-width modulation is a known control method used for switching the power supplied to electronic devices, for example a DC motor, light-emitting diode (LED) or the like, ON and OFF rapidly. According to this method of control, a DC voltage is converted into a square-wave signal, which alternates between for example, fully ON and zero, giving the electronic device a series of power “kicks”. For example, when the switching frequency is high enough, a DC motor can run at a steady speed due to its fly-wheel momentum and for example a LED can appear to emit a substantially constant level of illumination. By adjusting the duty cycle of the pulse width modulation signal, namely modulating the width of the pulse which corresponds to the time fraction that the electronic device is “ON” for a given cycle time period, the time-averaged power can be varied. In this manner the motor speed of a DC motor or the illumination level generated by a LED can be adjusted.

An example of pulse width modulation is illustrated in FIG. 1, wherein for a given duty cycle the ON pulse width 10, repeats every cycle time period 20 in a periodic nature.

There are a number of patents that relate to the use of pulse width modulation for the control of the activation of electronic device, for example an LED.

U.S. Pat. No. 5,008,788 describes a multi-color illumination apparatus for use in backlighting of liquid crystal display (LCD) devices. The illumination device includes pairs of LED dies, which can be controlled by the magnitude and duration of the voltage potential applied in the given proper polarity, for example, a voltage may be applied with a pulse width modulation to produce a continually varying third color of light.

U.S. Pat. No. 6,806,659, describes an illumination apparatus including a plurality of LEDs, wherein the activation of the LEDs is provided by a controller that generates pulse width modulated signals having duty cycles corresponding to the intensity values and a switch that directs current to the LEDs based on the pulse width modulated signals.

U.S. Pat. No. 6,967,448 describes methods and an apparatus for controlling illumination generated by a light source based on one or more interruptions of power supplied to the light source. This patent further defines that a controller coupled to a light source outputs and sends one or more control signals to the light source, wherein the control signals may include one or more pulse width modulated signals.

U.S. Pat. Nos. 6,016,038 and 6,788,011 describe systems and methods relating to LED systems capable of generating light, such as for illumination or display purposes. The LEDs may be controlled by a processor to alter the brightness and/or color of the generated light, for example by using pulse-width modulated signals. The resulting illumination may be controlled by a computer program to provide complex, predesigned patterns of light.

U.S. Pat. No. 6,965,205 describes various implementations of light emitting diode (LED) based illumination products and methods. A lighting system or device is described which may include a user interface, a processor, one or more controllers, one or more LEDs, and a memory. The processor may execute a program stored in the memory to generate signals that control stimulation of the LEDs. The signals may be converted by the controllers into a form suitable for driving the LEDs, which may include controlling the current, amplitude, duration, or waveform of the signals impressed on the LEDs. The controller may be a pulse width modulator, pulse amplitude modulator, pulse displacement modulator, resistor ladder, current source, voltage source, voltage ladder, switch, transistor, voltage controller, or other controller.

U.S. Pat. No. 6,975,079 describes methods and systems for controlling the conversion of data inputs to a computer-based light system into lighting control signals. The methods and systems include facilities for controlling a nonlinear relationship between data inputs and lighting control signal outputs. The nonlinear relationship may be programmed to account for varying responses of the viewer of a light source to different light source intensities. The light system includes light sources such as LEDs that generate light at different intensities in response to control signals, currents, or the like, such as pulse width modulation (PWM) control signals.

U.S. Pat. No. 6,897,624 describes an intelligent lighting device that can receive signals and change the illumination conditions as a result of the received signals. The lighting device can change hue, saturation, and brightness in response to received signals. The lighting device includes a controller which controls the output of, for example, an LED. The controller could be a pulse width modulator, pulse amplitude modulator, pulse displacement modulator, resistor ladder, current source, voltage source, voltage ladder, voltage controller or other power controller.

A problem with pulse width modulation control is the periodic nature of the requirement of power from a power supply. For example if a single power supply is providing power to multiple electronic devices operating at the same switching frequency, a periodically uneven load on the power supply can result.

U.S. Pat. No. 6,972,534 describes a control system for an electric machine that compensates for the delay introduced by variable-delay random pulse width modulation. The control system has a random pulse width modulation module that generates a switching period and a delay for a current cycle. The control system further has a phase angle compensation module that sums a sample rate, one half of the switching period and the delay of a previous cycle and subsequently outputs a delay time. The phase angle compensation module further multiplies the delay time and the electric angular velocity value and generates a compensating angle.

U.S. Pat. No. 6,600,669 describes a system and method for executing random pulse width modulation in electronic power converters. The sampling period of the sampling cycles for pulse width modulation remains constant while the period of the switching cycles are varied. The periods of the switching cycles are varied using random numbers to calculate delays between the start of coincident sampling and switching cycles.

For operation of an electronic device using pulse width modulation, typically specialized microcontrollers are used which comprise on-chip specialized PWM units. Therefore this configuration can result in a more costly design of a control system for electronic devices, as specialized components are required rather than typically cheaper generic components, for example generic microprocessors.

Therefore, there is a need for a new method and apparatus for controlling the activation of an electronic device.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus and method for controlling activation of an electronic device. In accordance with an aspect of the present invention, there is provided a method for controlling activation of an electronic device, the method comprising the steps of: obtaining a desired activation ratio for a predetermined time period, the activation ratio representative of an ON time period of the electronic device relative to the predetermined time period; determining an activation sequence for the electronic device, the activation sequence including two or more activation time periods and one or more deactivation time periods, wherein the two or more activation time periods relative to the predetermined time period is equivalent to the activation ratio.

In accordance with another aspect of the present invention, there is provided an apparatus for controlling activation of an electronic device, the apparatus comprising: means for obtaining a desired activation ratio for a predetermined time period, the activation ratio representative of an ON time period of the electronic device relative to the predetermined time period; means for determining an activation sequence for the electronic device, the activation sequence including two or more activation time periods and one or more deactivation time periods, wherein the two or more activation time periods relative to the predetermined time period is equivalent to the activation ratio.

In accordance with another aspect of the present invention, there is provided an apparatus for controlling activation of an electronic device, the apparatus comprising: a memory holding a plurality of activation sequences, each of the activation sequences associated with a particular activation ratio and a predetermined time period, each activation sequence including two or more activation time periods and one or more deactivation time periods, wherein the two or more activation time periods relative to a predetermined time period is equivalent to the particular activation ratio; a controller configured to receive a desired activation ratio for the predetermined time period, the controller further configured to access the memory and determine the activation sequence that corresponds to the desired activation ratio and the controller configured to generate control signals based on the determined activation ratio and transmit the control signals to the electronic device.

In accordance with another aspect of the present invention, there is provided a computer program product comprising a computer readable medium having recorded thereon statements and instructions for execution by a processor to carry out a method for controlling activation of an electronic device comprising the steps of: obtaining a desired activation ratio for a predetermined time period, the activation ratio representative of an ON time period of the electronic device relative to the predetermined time period; determining an activation sequence for the electronic device, the activation sequence including two or more activation time periods and one or more deactivation time periods, wherein the two or more activation time periods relative to the predetermined time period is equivalent to the activation ratio.

### BRIEF DESCRIPTION OF THE FIGURES

FIG. 1 illustrates two pulse width modulation cycles for controlling an electronic device according to the prior art.

FIG. 2 illustrates two cycles for controlling activation of an electronic device according to one embodiment of the present invention.

FIG. 3 illustrates rotation of a bit string according to one embodiment of the present invention.

FIG. 4 illustrates an embodiment of the apparatus for controlling the activation of an electronic device according to one embodiment of the present invention.

FIG. 5 is a flow chart illustrating a control method according to one embodiment of the present invention.

FIG. 6 is a flow chart illustrating a control method according to another embodiment of the present invention.

FIG. 7 illustrates an implementation of the control method as illustrated in FIG. 6.

FIG. 8 illustrates another implementation of the control method as illustrated in FIG. 6.

FIG. 9 illustrates another implementation of the control method as illustrated in FIG. 6.

### DETAILED DESCRIPTION OF THE INVENTION

### Definitions

The term “electronic device” is used to define a device wherein its level of operation is dependent on the voltage or current being supplied thereto. Examples of an electronic device include a light-emitting element, DC motor, laser diode and other device requiring current regulation as would be readily understood by a worker skilled in the art.

The term “light-emitting element” is used to define a device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art.

The term “controller” is used to define a computing device or microcontroller having a central processing unit (CPU) and peripheral input/output devices (such as A/D or D/A converters) to monitor parameters from peripheral devices that are operatively coupled to the controller. These input/output devices can also permit the CPU to communicate and control peripheral devices that are operatively coupled to the controller. The controller can optionally include one or more storage media collectively referred to herein as “memory”. The memory can be volatile and non-volatile computer memory such as RAM, PROM, EPROM, EEPROM, magnetic disks, optical disks, magnetic tape, or the like, wherein control programs (such as software, microcode or firmware) for monitoring or controlling the devices coupled to the controller are stored and executed by the CPU. Optionally, the controller also provides the means of converting user-specified operating conditions into control signals to control peripheral devices coupled to the controller. The controller can receive user-specified commands by way of a user interface, for example, a keyboard, a touchpad, a touch screen, a console, a visual or acoustic input device as is well known to those skilled in this art. The term “controller” may additionally be used to describe a field-programmable gate array (FPGA) and application-specific integrated circuits (ASIC) or other suitable device as would be known to a worker skilled in the art.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a method and apparatus for controlling the activation of an electronic device. For a desired activation ratio, which defines the “ON” time relative to the “OFF” time of the electronic device for a given time period, the method and apparatus according to the present invention evaluates an activation sequence. The activation sequence comprises two or more activation time periods and one or more deactivation time periods, wherein the ratio between the two or more activation time periods and the given time period is equivalent to the desired activation ratio.

The apparatus and method according to the present invention subdivides a single activation time span defined by the activation ratio for a given time period, into two or more activation time periods for the given time period. The process of subdividing the single activation time span can be performed in order to reproducibly determine the two or more activation time periods, or can be performed such that the two or more activation time periods are substantially randomly determined.

The activation of an electronic device can be performed at a plurality of resolution levels, R, wherein the resolution level defines the granularity of the possible levels of control of the electronic device, for example the number of discrete activation levels, which can be defined by the number of bits providing the information relating to the digital control of the electronic device. For example, an electronic device controlled at 2-bit resolution level, can have 4 different operational levels, namely 2². Likewise, an electronic device being controlled at 8-bit resolution level can have 256 different operational levels, namely 2⁸.

### Activation Sequence Generation

In one embodiment of the present invention, for a given activation ratio, A, for a given time period, TP, the activation time periods of an activation sequence are determined in order that they satisfy the following:

$${\sum }_{i = 1}^{N} {P}_{i} ( t ) = {A}^{*} TP \qquad ( 1 )$$

where Pᵢ(t) is the time duration of the i^{th} ON pulse and N is the number of activation time periods.

In another embodiment of the present invention, the activation time periods of an activation sequence are determined in order to satisfy the following:

$${\sum }_{i = 1}^{N} {P}_{i} ( t ) = {A}^{m *} TP \qquad ( 2 )$$

where m can be selected as an integer, for example 2 or 3. For example, having particular regard to the activation of a light-emitting element, the term m can allow the light-emitting element intensity to be directly proportional to the square or cube of the activation ratio, thereby substantially complying with square law dimming or cubic law dimming for light sources, respectively.

In another embodiment of the present invention for a given time period, TP, and a resolution level, R, the activation time periods ONtimePᵢ and deactivation time periods OFFtimePⱼ of an activation sequence are determined in order that they satisfy the following:

$${\sum }_{i = 1}^{N} {ONtimeP}_{i} + {\sum }_{j = 1}^{M} {OFFtimeP}_{j} = TP \qquad ( 3 )$$

where N+M=R, wherein N is the number of ON time pulses with a length t, M is the number of OFF time pulses of length t, N/M=A which is the activation ratio, and TP=2^{R}t, wherein t is the smallest length of pulse that can be generated by the controller.

In one embodiment of the present invention, each of the activation time periods of an activation sequence is randomly selected provided that one of the above conditions as defined by Equation 1 or 2 or 3, is satisfied. For random generation of the activation time periods, the controller can be configured to perform a substantially random generation sequence in order to determine one or more of the activation time periods. For example, a random number generator configured within the controller can be used to perform the substantially random generation of the activation time periods. In one embodiment, the random number generator can use the clock time of the controller as the seed values for the random number generator, wherein the clock time can be representative of the time of initial energization of the controller, for example. The evaluation of other seed values would be readily understood by a worker skilled in the art.

Substantially random determination of the activation time periods of an activation sequence, however, is linked to the desired activation ratio and the available control resolution level for the electronic device. For example, for a given resolution level, as the activation ratio decreases the number of different activation time periods that are possible for an activation sequence decreases, as an activation time period can have a minimum possible time span.

In one embodiment, one or more of the activation time periods is evaluated based on a predetermined criteria or formulation.

In one embodiment of the present invention, the first activation time period can be defined as the smallest activation time period that can be generated given an assigned resolution level and a predetermined time period. For example, given an 8-bit resolution level, R, there are therefore substantially 256 (2⁸) discrete levels of control of the electronic device. Furthermore given, for example, that the frequency of control is 30 kHz, the predetermined time period is equivalent to about 33.33 μsec. Therefore, for this example the smallest activation time period is equivalent to about 130 nsec, (33.33 μsec/256).

In another embodiment of the present invention, the smallest activation time period is dependent on the central clock associated with the controller performing the calculations, in addition to the processing power and amount of calculations required to perform the method of the present invention.

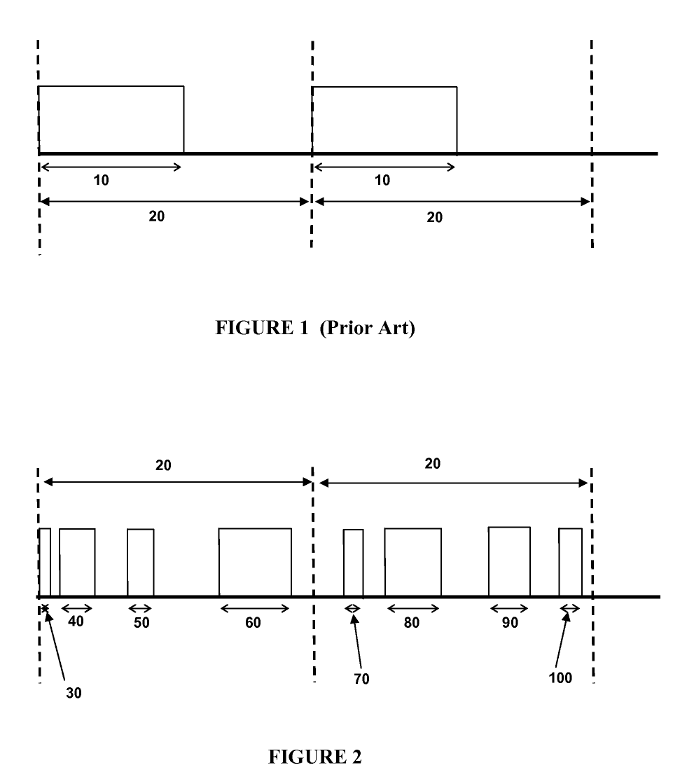

FIG. 2 illustrates two different activation sequences configured according to one embodiment of the present invention. With regard to FIG. 2, the activation ratio is that as defined by the periodic pulse width modulation signal illustrated in FIG. 1. As illustrated, in each of the predetermined time periods 20, the activation sequence defined according to this embodiment comprises four activation time periods, wherein the summation of activation time periods 30, 40, 50 and 60 is equivalent to the time period defined by the ON pulse width, illustrated as 10 in FIG. 1. Likewise the summation of activation time periods 70, 80, 90 and 100 is also equivalent to the time period defined by the same ON pulse width. According to other embodiments of the present invention, the number of activation time periods may be for example 2, 3, 5, 6 or more.

In one embodiment of the present invention, the memory associated with the controller can be used to store a pre-evaluated set of activation sequences, each activation sequence associated with an activation ratio as defined by the resolution level associated with the operational levels of the electronic device.

In one embodiment, for an R-bit resolution level and N activation time periods, the memory can store R²N bit strings having 2^{R} bits, each string indicative of an activation sequence. In this configuration each of the bit strings represent an activation ratio in binary format. In this memory storage configuration, upon receipt of data relating to a specific activation ratio, the controller can extract the identified information or bit string, from memory in order to determine the activation sequence.

In another embodiment, for an R-bit resolution level, the memory can store 2^{R} bit strings having 2^{R} bits, each string indicative of an activation sequence. In this configuration each of the bit strings represent an activation ratio in binary format. In this memory storage configuration, upon receipt of data relating to a specific activation ratio, the controller can extract the identified information or bit string, from memory in order to determine the activation sequence.

In another embodiment of the present invention, conservation of memory can be provided by only storing ½ R²N bit strings having 2^{R} bits, each string indicative of two activation sequences. A first activation sequence being represented by the string and the second activation sequence being represented by the bit-wise inversion of the string. In this memory configuration, the controller receives data relating to a specific activation ratio and when the data identifies a bit string of less than ½ R²N, the controller extracts the identified information or bit string from memory in order to determine the activation sequence. However, when the data identifies a bit string of greater than or equal to ½ R²N, the controller extracts the complementary information from memory and subsequently inverts this complementary information and uses the complementary information or bit string to determine the activation sequence.

In another embodiment of the present invention, conservation of memory can be provided by only storing ½ 2^{R} bit strings having 2^{R} bits, each string indicative of two activation sequences. A first activation sequence being represented by the string and the second activation sequence being represented by the inverse of the string. In this memory configuration, the controller receives data relating to a specific activation ratio and when the data identifies a bit string of less than ½ 2^{R}, the controller extracts the identified information or bit string from memory in order to determine the activation sequence. However, when the data identifies a bit string of greater than or equal to ½ 2^{R}, the controller extracts the complementary information from memory and subsequently inverts this complementary information and uses the inverted complementary information or bit string to determine the activation sequence.

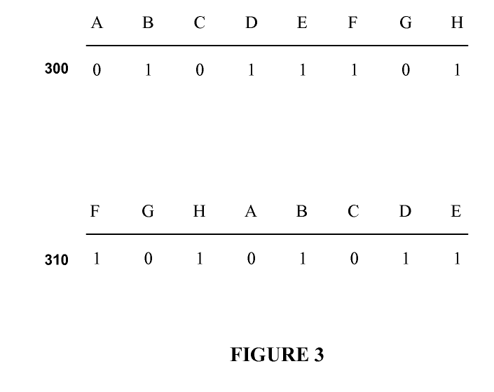

In one embodiment of the present invention, prior to output of the activation sequence, the information extracted from memory is substantially randomly rotated, for example by the controller. An example of information or bit string rotation is illustrated in FIG. 3. In this example the information is configured as an 8-bit string 300, and upon extraction of string 300, the string is rotated three bits to the right, resulting in bit string 310. In this example, a letter has been assigned to each bit for ease of reference to the bit locations.

In one embodiment of the present invention, the bit string indicative of an activation sequence can be substantially randomly rotated for each time period. This procedure may enable the reduction of harmonic content of the control signal, which may thereby reduce the possibility of electromagnetic interference and acoustic resonance of the transformers and wire wound inductors of the power supply, for example.

In another embodiment of the present invention, for an R-bit resolution level and hence 2^{R} bits per activation time period, the order of bits in each bit string is pseudo-randomly shuffled using for example a linear-time shuffling algorithm such as the Fisher-Yates shuffle, as described for example by Mark C. Wilson in “Random and Exhaustive Generation of Permutations and Cycles.” Written in pseudocode, this algorithm is:

FOR i = 2^{R} − 1 TO 1

r = rand(0,i)
tmp = bit_string[i]
bit_string [i] = bit_string [r]
bit_string [r] = tmp

ENDFOR

where i, r and tmp are temporary integer variables and rand (0,i) is a function that returns a pseudorandom integer in the range of 0 to i. In accordance with Equation 1, a pulse width signal as shown for example in FIG. 1 may be converted into a randomized bit string without the need to store predetermined bit strings in read-only memory.

In another preferred embodiment of the present invention for an R-bit resolution level and hence 2^{R} bits per activation time period, the bit string is conceptually divided into 2^{S} sequentially arranged sets of 2^{R-S} bits, and the order of sets in each bit string is pseudorandomly shuffled using for example a linear-time shuffling algorithm such as the Fisher-Yates shuffle. This has the advantage that each bit string is randomized with a reduction of 2^{R-S} times in computational cost.

In one embodiment of the present invention, the evaluation of the activation sequence is performed at a refresh rate that is greater than about 100 Hz, and in another embodiment the refresh rate is about 200 Hz.

In one embodiment of the present invention, the control method and apparatus can be used for the operation of a lighting device comprising one or more light-emitting elements. In this embodiment of the present invention, the switching speed of the light-emitting element should be greater than the fusion rate of the human eye, for example greater than between about 60 and 100 Hz, in order to ensure that the light emitted by the one or more light-emitting elements appears as a time-averaged brightness of the emitted light and not as a sequence of light pulses. In an alternate embodiment of the present invention, the switching speed of the light-emitting element is configured to be greater than 200 Hz or 500 Hz or higher.

In another embodiment, the plurality of activation sequences may be synchronized with each bit string being rotated by an independent and substantially random number of bits. In this embodiment, even if all channels are set to the same activation ratio, the output strings determined for each channel will typically be uncorrelated, thereby resulting in a substantially constant load on the power supply.

In one embodiment of the present invention, the number of channels that can be used for output of the activation sequences from the controller can be dependent on the number of general purpose input/output (GPIO) channels associated with the controller, for example the CPU.

In one embodiment of the present invention, the controller used to perform the method according to the present invention, can be configured with a dual CPU architecture. This configuration of the controller can be used for communication with one or more external controllers and for generating the activation sequences. For example, one CPU can be configured as a communication processor which can receive input data and provide the second CPU with instructions relating to the generation of the activation sequences. The second CPU can also be configured to output the evaluated activation sequences for one or more electronic devices.

In one embodiment of the present invention, the activation sequences generated by the controller are asynchronous to other activation sequences. In this configuration, if multiple electronic devices are being controlled by one controller which can draw power from a single power supply, the asynchronous manner of the multiple activation sequences can result in a substantially constant load on a power supply providing the required power to the electronic devices.

In another embodiment of the present invention, the method according to the present invention can be configured as firmware or software for example. In this configuration substantially any controller or microprocessor can be configured to perform the method according to the present invention.

In another embodiment of the present invention, the resolution level can be arbitrarily selected based on a desired level of granularity of operation of the one or more electronic devices. The selected resolution level can be used by the controller for the evaluation of the activation sequence without the need for reconfiguration of the controller as the controller's functionality for the generation of the activation sequence can be provided by firmware or software stored in the memory of the controller.

The invention will now be described with reference to specific examples. It will be understood that the following examples are intended to describe embodiments of the invention and are not intended to limit the invention in any way.

### Apparatus

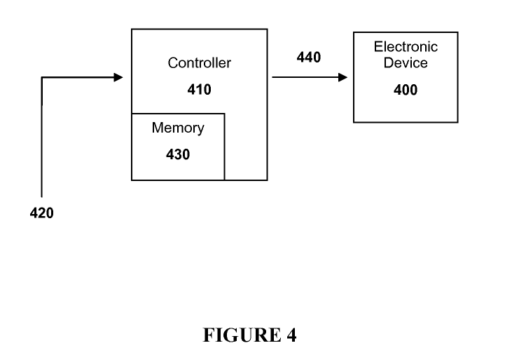

An apparatus for controlling the activation of an electronic device according to one embodiment of the present invention is illustrated in FIG. 4. The controller 410 receives input data 420 which can define a desired resolution level. The controller can access memory 430 which comprises a series of instructions according to an embodiment of the present invention, which when executed by a central processing unit associated with the controller, enables the controller to calculate and generate an activation sequence for controlling the activation of the one or more electronic devices 400 associated therewith. The activation sequence can be transmitted to the electronic device by the controller in a format of control signals 440 which are compatible with the electronic device being controlled.

### Examples

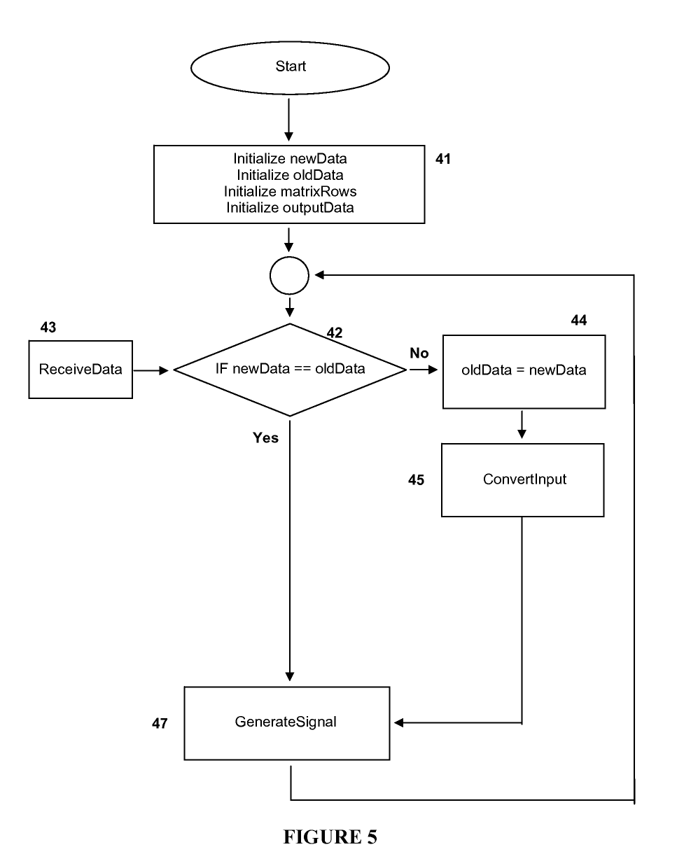

FIG. 5 presents a flow chart illustrating the control method according to one embodiment of the present invention. Initially, a resolution level R, is set and the number of channels, NUM_CHAN, for data transmission is determined based on the hardware configuration. These parameters provide a means for the configuration of the memory of the controller as occurs in step 41. Following configuration, the controller continually loops through steps 42 and 47 for each time period. Input data representing the desired activation ratio A is asynchronously received in step 43, wherein it is stored in memory newData. At the beginning of each time period loop, this data is compared with the data currently stored in memory oldData. If the new data is different from the old data, the old data is replaced with the new data in step 44. The input data is then used in step 45 to generate a new, random bit string for each channel, wherein function ConvertInput initializes the two-dimensional bit array matrixRows with 2^{R}*NUM_CHAN elements, wherein each of the NUM_CHAN rows represents a bit string for its associated control channel. If the new data is the same as the old data, control flow proceeds directly from step 42 to step 47.

In step 47, function GenerateSignal randomly rotates the bit strings of each row in matrixRows, then synchronously outputs the NUM_CHAN bit string data in a serial manner before returning control to step 42.

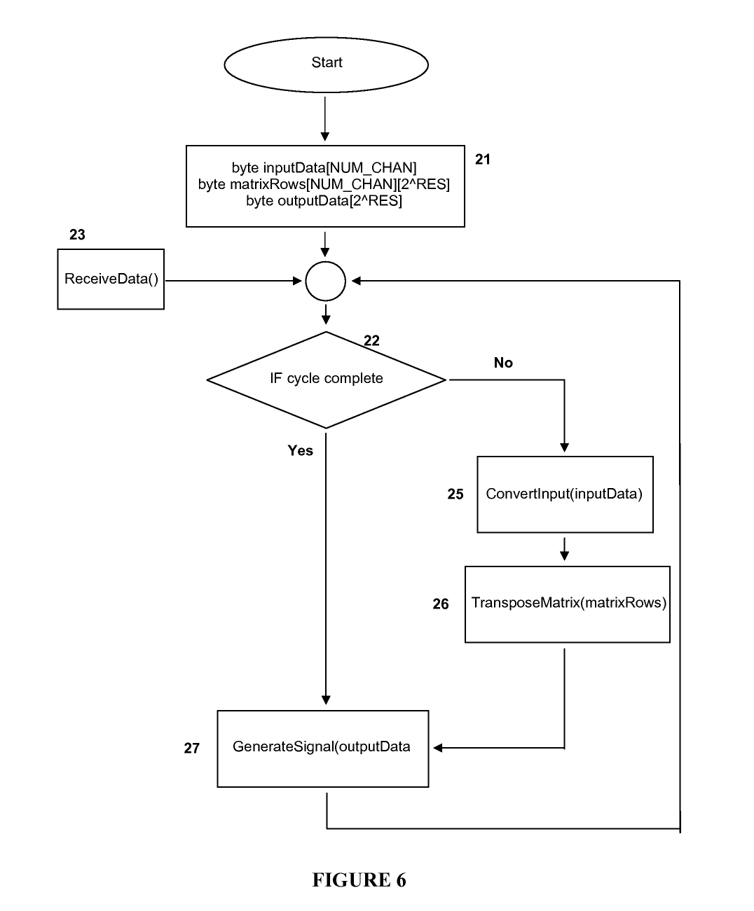

FIG. 6 presents a flow chart illustrating the control method according to another embodiment of the present invention. Initially, a resolution level, R, is set and the number of channels, NUM_CHAN, for data transmission is determined based on the hardware configuration. These parameters provide a means for the configuration of the memory of the controller as occurs in step 21. Data is being output constantly. If the refresh cycle is completed, new data is calculated (outputData) and this data is sent to the controller outputs using function void GenerateSignal (byte outputData[2^{R}]) step 27. Once all of the resolution levels (2^{R}) have been output by the controller, a refresh cycle has been completed.

New data is received with ReceiveData( ) at step 23 and stored in the inputData[NUM_CHAN] array. Subsequently a new substantially random sequence for each element of the arrays defined in memory is determined, wherein the ConvertInput step 25 generates a 2-dimensional bit array with [2^{R}][NUM_CHAN] elements. This 2-dimensional array is subsequently used as input for TransposeMatrix(byte matrixRows[2^{R}][NUM_CHAN]) at step 26. This function takes the input matrix [2^{R}][NUM_CHAN] matrixRows, reads its columns, stores it in byte outputData[2^{R}] which is used as input by the GenerateSignal function 27.

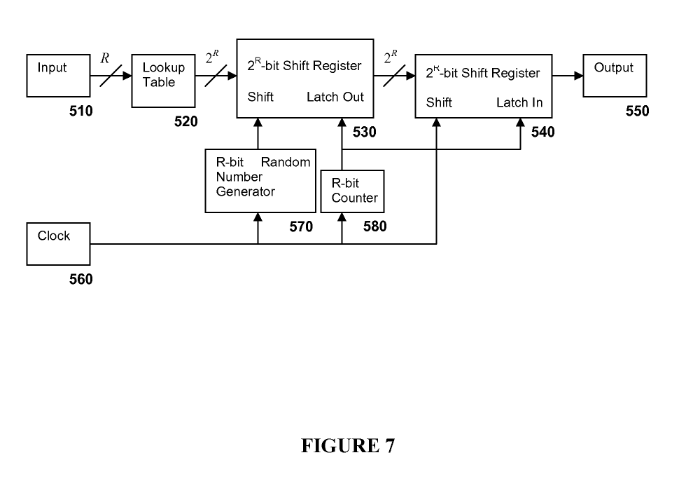

The flow chart illustrating the control method according to an embodiment of the present invention as illustrated in FIG. 6, may be implemented in firmware. A firmware implementation according to one embodiment of the present invention is illustrated in FIG. 7.

Having regard to FIG. 7, input 510 corresponds to the step of ReceiveData 23 as indicated FIG. 6. The received data comprises NUM_CHAN words with R bits per word, wherein R is the resolution level. For the purposes of illustration, only one channel is illustrated in FIG. 7. Each received word is asynchronously translated into a bit string with 2^{R} bits by lookup table 520 which comprises 2^{R} words.

Clock 560 has a period of TP/2^{R}, wherein TP is the time period and each clock pulse increments random number generator 570 and counter 580. Counter 580 generates an output pulse each time it rolls over at 2^{R} counts. This pulse causes parallel-in/parallel-out shift register 530 to latch its current contents on its output and then load the 2^{R} bit string generated by lookup table 520. The pulse also causes parallel in/serial out shift register 540 to latch its input from shift register 530.

The least significant bit of random number generator 570 is connected to the shift control of shift register 530, and the serial output of shift register 530 is connected to the serial input of shift register 540. Thus, the 2^{R} bit string loaded from lookup table 520 is randomly rotated by up to 2^{R}−1 bits per time period.

The random number generator 570 can be implemented in hardware using for example a linear feedback shift register, as is known to those skilled in the art. For example, a 16-bit serial-in/parallel-out shift register with outputs 3, 12, 14, and 15 exclusive-OR'd and fed back into the input will generate a 16-bit pseudorandom number with a sequence length of 65,535.

Once shift register 540 has latched its input, each pulse from clock 560 shifts its contents by one bit, thereby implementing the TransposeMatrix function 26 as identified in FIG. 6.

The serial output of shift register 540 thereby generates the pseudorandom pulse code data for output device 550. As may be appreciated, each channel requires its own input 510, lookup table 520, parallel-in/parallel out shift register 530, parallel-in/serial-out shift register 540, and output device 550. These components are synchronously clocked by the common clock 560, random number generator 570, and counter 580.

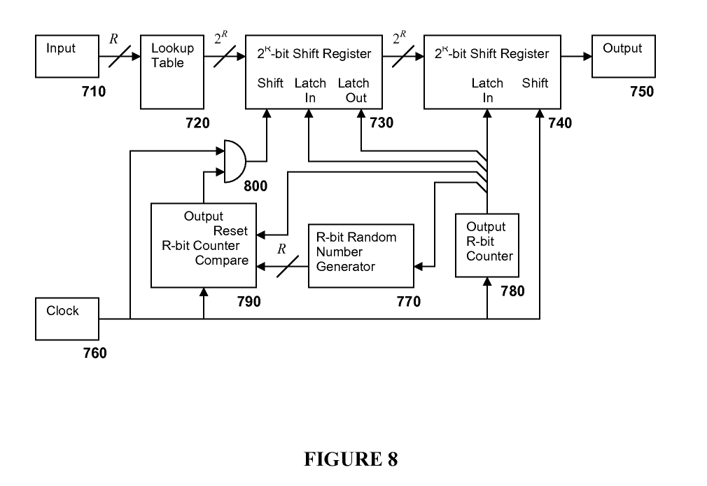

With further reference to the flow chart illustrating the control method according to an embodiment of the present invention as illustrated in FIG. 6, according to another embodiment of the present invention this method may be implemented in firmware as illustrated in FIG. 8.

Having regard to FIG. 8, input 710 corresponds to the step of ReceiveData 23 as indicated FIG. 6. The received data comprises NUM_CHAN words with R bits per word, wherein R is the resolution level. For the purposes of illustration, only one channel is illustrated in FIG. 7. Each received word is asynchronously translated into a bit string with 2^{R} bits by lookup table 720 which comprises 2^{R} words.

Clock 760 has a period of TP/2^{R}, wherein TP is the time period and each clock pulse increments counters 780 and 790, and shifts the contents of shift register 740. Through AND gate 800, each clock pulse also shifts the contents of shift register 730. Counter 780 generates an output pulse each time it rolls over at 2^{R} counts. This pulse causes parallel-in/parallel-out shift register 730 to latch its current contents on its output and then load the 2^{R} bit string generated by lookup table 720. The pulse also causes parallel in/serial out shift register 740 to latch its input from shift register 730. and causes random number generator 770 to generate an R-bit random number, and resets counter 790.

The random number generator 770 can be implemented in hardware using for example a linear feedback shift register, as is known to those skilled in the art. For example, a 16-bit serial-in/parallel-out shift register with outputs 3, 12, 14, and 15 exclusive-OR'd and fed back into the input will generate a 16-bit pseudorandom number with a sequence length of 65,535.

The R-bit output of random number generator 770 is connected to the compare input of R-bit counter 790. When the output of counter 790 equals the value of the random number, counter 790 sets its output low and so disables further bit shifting of shift register 730 until counter 790 is reset. Thus, the 2^{R} bit string loaded from lookup table 720 is randomly rotated by up to 2^{R}−1 bits per time period.

Once shift register 740 has latched its input, each pulse from clock 760 shifts its contents by one bit, thereby implementing the TransposeMatrix function 26 as identified in FIG. 6.

The serial output of shift register 740 thereby generates the pseudorandom pulse code data for output device 750. As may be appreciated, each channel requires its own input 710, lookup table 720, parallel-in/parallel out shift register 730, parallel-in/serial-out shift register 740, and output device 750. These components are synchronously clocked by the common clock 760, random number generator 770, counters 780 and 790 and AND gate 800.

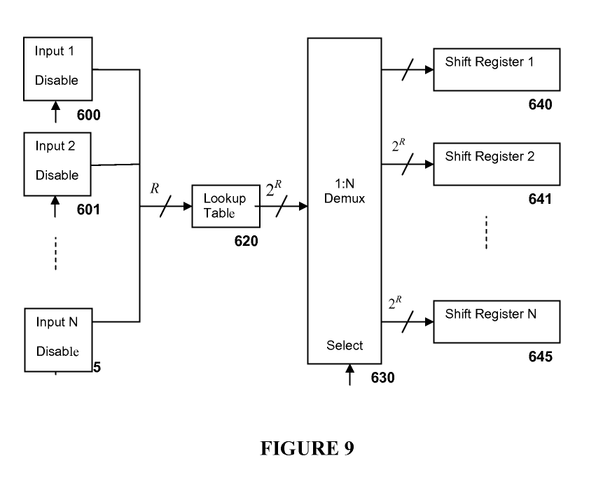

With yet further reference to the flow chart illustrating the control method according to an embodiment of the present invention as illustrated in FIG. 6, according to yet another embodiment of the present invention this method may be implemented as illustrated in FIG. 9.

Having particular regarding to FIG. 9, each of the N inputs 600, 602, . . . 605 (where ‘N’ represents the number of channels) is provided with a high-impedance output disable and are connected in parallel to the lookup table 620 input. A 1:N demultiplexer 630 is interposed between the lookup table 620 output and the N parallel-in/parallel-out shift registers 640, 641, . . . 645. The inputs 600, 601 . . . 605 and demultiplexer 630 are then sequentially selected to obtain the N bit strings corresponding to the N input words.

As may be appreciated by one skilled in the art, the circuits as defined herein may be implemented in hardware using for example a field-programmable gate array (FPGA) or application-specific integrated circuit (ASIC), or other hardware as would be readily understood by a worker skilled in the art.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on a controller for example a computing device or microcontroller having a central processing unit (CPU) or the like and pursuant to one or more, or a part of one or more, program elements, modules or objects generated from any programming language, such as C++, Java, Pl/1, or the like. In addition, each step, or a file or object or the like implementing each said step, may be executed by special purpose hardware or a circuit module designed for that purpose.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

We claim:

1. A method for controlling activation of an electronic device, the method comprising the steps of:
a) obtaining a desired activation ratio for a predetermined time period, the activation ratio representative of an ON time period of the electronic device relative to the predetermined time period;
b) determining an activation sequence for the electronic device, the activation sequence including two or more activation time periods and one or more deactivation time periods, wherein the two or more activation time periods relative to the predetermined time period is equivalent to the activation ratio.

2. The method according to claim 1, wherein during the step of determining the activation sequence, the two or more activation time periods are reproducibly determined.

3. The method according to claim 1, wherein during the step of determining the activation sequence, the two or more activation time periods are randomly determined.

4. The method according to claim 1, wherein one of the two or more activation time periods is defined at a smallest activation time period, wherein the smallest activation time period is indicative of a resolution level and the predetermined time period.

5. The method according to claim 1, wherein one of the two or more activation time periods is defined at a smallest activation time period, wherein determining the activation sequence is performed by a controller having a central clock, wherein the smallest activation time period is indicative of the central clock.

6. The method according to claim 1, wherein the activation sequence is stored in a memory upon determination.

7. The method according to claim 1, wherein the activation sequence is randomly rotated.

8. The method according to claim 1, wherein evaluation of the activation sequence is refreshed at a rate greater than 100 Hz.

9. The method according to claim 8, wherein the evaluation of the activation sequence is refreshed at a rate of about 200 Hz.

10. An apparatus for controlling activation of an electronic device, the apparatus comprising:
a) means for obtaining a desired activation ratio for a predetermined time period, the activation ratio representative of an ON time period of the electronic device relative to the predetermined time period;
b) means for determining an activation sequence for the electronic device, the activation sequence including two or more activation time periods and one or more deactivation time periods, wherein the two or more activation time periods relative to the predetermined time period is equivalent to the activation ratio.

11. The apparatus according to claim 10, comprising a controller configured with a dual central processing unit architecture.

12. The apparatus according to claim 11, wherein a first central processing unit is configured as a communication processor and a second central processing unit is configured to generate the activation sequence.

13. The apparatus according to claim 10, wherein a plurality of activation sequences are evaluated and stored in a memory means operatively coupled to the apparatus.

14. An apparatus for controlling activation of an electronic device, the apparatus comprising:
a) a memory holding a plurality of activation sequences, each of the activation sequences directly representative of a particular activation ratio and a predetermined time period, each activation sequence including two or more activation time periods and one or more deactivation time periods, wherein the two or more activation time periods relative to a predetermined time period is equivalent to the particular activation ratio;
b) a controller configured to receive a desired activation ratio for the predetermined time period, the controller further configured to access the memory and determine the activation sequence that corresponds to the desired activation ratio and the controller configured to generate control signals based on the determined activation ratio and transmit the control signals to the electronic device

15. The apparatus according to claim 14, wherein the memory comprises one activation sequence for each activation ratio.

16. The apparatus according to claim 14, wherein the memory comprises one activation sequence for two related activation ratios.

17. The apparatus according to claim 16, wherein one activation sequence is directly representative of a first of the two related activation ratios and an inverse of the one activation sequence directly representative of a second of the two related activation ratios.

18. A computer program product comprising a computer readable medium having recorded thereon statements and instructions for execution by a processor to carry out a method for controlling activation of an electronic device comprising the steps of:
a) obtaining a desired activation ratio for a predetermined time period, the activation ratio representative of an ON time period of the electronic device relative to the predetermined time period;
b) determining an activation sequence for the electronic device, the activation sequence including two or more activation time periods and one or more deactivation time periods, wherein the two or more activation time periods relative to the predetermined time period is equivalent to the activation ratio.
